(19) United States
(12) Patent Application Publication
(10) Pub. No.: US 2023/0215660 A1
(43) Pub. Date: Jul. 6, 2023

(54) FILM CAPACITOR

(71) Applicant: Siemens Aktiengesellschaft, München (DE)

(72) Inventors: Marion Junghänel, Marloffstein (DE); Bernd KÜRTEN, Obermichelbach (DE); Helmut BRENDEL, Erlangen (DE); Alexander HENSLER, Gerhardshofen (DE); Philipp OSCHMANN, Erlangen (DE); Gerd HILBINGER, Emskirchen (DE)

(73) Assignee: Siemens Aktiengesellschaft, München (DE)

(21) Appl. No.: 17/927,834

(22) PCT Filed: May 4, 2021
(86) PCT No.: PCT/EP2021/061643

§ 371 Date: Nov. 25, 2022

(30) Foreign Application Priority Data
May 28, 2020 (EP) 20177143.3

(51) Int. Cl. H01G 4/33; H01G 4/32; H01G 4/30

(52) U.S. Cl. CPC H01G 4/33; H01G 4/32; H01G 4/306

(57) ABSTRACT

A film capacitor includes first and second contact layers and a metallized dielectric film with first and second end faces and with first and second film sides. The first end face of the metallized dielectric film is connected to the first contact layer and the second end face is connected to the second contact layer. The metallized dielectric film has first, second and third metallization layers, with at least two of the metallization layers applied on the first film side of the metallized dielectric film and at least a further of the metallization layers applied on the second film side. The metallization layers are arranged on the film sides in such a manner that a first overlap with a first partial capacitance and a second overlap with a second partial capacitance are embodied between the metallization layers on the film sides, with the partial capacitances forming a series connection.

The invention relates to a film capacitor, comprising at least one metallized dielectric film with a first and second end face and with a first and second film side and a first and second contact layer, wherein the first end face of the metallized dielectric film is connected to the first contact layer and the second end face of the metallized dielectric film is connected to the second contact layer and the metallized dielectric film has a first, second and third metallization layer. The invention further relates to a filter with the film capacitor and a converter with the filter.

Capacitors are used in a wide variety of ways in almost all electrical and electronic devices and systems in the field of automation and drive technology, in particular for applications in the field of industry and power generation and power distribution. The application for capacitors thus extends for example from briefly storing energy, to stabilizing network voltages and improving electromagnetic compatibility (EMC), to supporting device-specific functions, such as the coupling of signals in crossovers for acoustic devices, for example.

Here, it is also possible in particular to highlight the use of capacitors in electrical filters, which firstly at least restrict the emission of electrical interference by electronic devices, for example of electrical converters, in electrical networks, and also improve the electromagnetic compatibility of electrical devices of this kind in relation to interference from the network.

The possible designs and electrical constructions for a capacitor are numerous and depend, inter alia, upon the electrical use conditions, the fundamental use purpose and qualitative requirements, wherein the cost factor also cannot be ignored.

In the proper sense, film capacitors are plastic film capacitors in particular. Due to the features of their construction, they possess very low resistive losses and parasitic inductances. As a result, they are suitable for applications in high frequency ranges, for smoothing voltage peaks, interfering pulses or pulse edges, but also for a high pulse current-carrying capacity.

In a film capacitor, a plurality of dielectric films is often arranged in succession, layered accordingly, wherein a metallization layer is applied on one side or also on two sides of the individual dielectric films, depending on the kind of embodiment. In general, contact layers are applied on two opposite end faces of the dielectric films arranged in succession in each case, wherein the metallization layer is often contacted with the one or the other contact layer.

For example, the contact layers are sprayed onto the end face of the dielectric films arranged in succession in the form of a liquefied metal. In this context, the dielectric films arranged in succession are wound around an axis, for example, and may be surrounded by a plastic shell in order to protect from environmental influences, in particular from moisture. The electrical contacting of the film capacitor formed in this way then can only take place out of the plastic shell.

Often, during the production but also during the operation of the film capacitors, gaps filled with air may form between a dielectric film and a metallization layer. In the case of operation, due to the dielectric polarization of the dielectric film due to a metallization layer that is applied on its opposite side and contacted to the opposite pole, high field strengths may occur in the air gaps. This may trigger partial discharges with voltage flashovers, which primarily occur at the locations at which the spacing is slightly reduced owing to unevenness of the two surfaces. When an AC voltage is applied, voltage flashovers of this kind take place periodically. A voltage flashover can also be caused by a voltage peak in the network voltage.

Due to a residual moisture in the film capacitor, which can hardly be avoided, the surface of a metallization layer oxidizes more and more over the course of its service life, which mostly leads to a passivation of its surface, and protects the metallization layer from deep-penetrating corrosion. A voltage flashover is able to overcome this passivation, which destroys the protective oxidation layer, and a deeper level of the metallization layer can now be oxidized. In the region of the voltage flashovers, it is therefore possible for the entire metallization layer to gradually oxidize, wherein the electrical resistance increases in this surface area zone.

If an oxidation of this kind occurs in the vicinity of the contacting with one or both of the contact layers, then the electrical binding of the metallization layer to the respective contact layer accordingly becomes higher-resistance as the service life continues, which leads to power losses in conjunction with an undesirable heating of the film capacitor due to the heat loss generated by the power loss.

This heating may lead to the complete destruction of the film capacitor, in particular even setting it on fire due to a melting of the dielectric film. This may result in an operational risk for the use of the film capacitors due to a reduced electrical availability of the film capacitor. This reduced electrical availability of the film capacitor often also has a decisive influence on the availability of the electrical devices and systems which use the film capacitor.

Due to general cost pressure, restricted spatial installation possibilities and the required weight reduction of electrical devices and systems, it also becomes necessary, for film capacitors to be used, to respond to these requirements, thereby dimensioning film capacitors not far beyond the use conditions for example, while still meeting high requirements for the electrical availability.

The object underlying the invention is therefore to propose a film capacitor, a filter with film capacitor and an electrical converter with the filter, which achieve an improved electrical availability in conjunction with improved operating data compared to the prior art.

The object is achieved by a film capacitor with the features specified in claim 1, by a filter with the film capacitor according to the features specified in claim 14 and a converter with the filter according to the features specified in claim 15.

To achieve the object, a film capacitor is proposed, which comprises at least one metallized dielectric film with a first and second end face and with a first and second film side and a first and second contact layer, wherein the first end face of the metallized dielectric film is connected to the first contact layer and the second end face of the metallized dielectric film is connected to the second contact layer and wherein the metallized dielectric film has at least a first, second and third metallization layer, characterized in that at least two of the metallization layers are applied on the first film side of the metallized dielectric film and at least a further of the metallization layers is applied on the second film side of the metallized dielectric film and the metallization layers are arranged on the first and second film side of the metallized dielectric film in such a manner that at least a first overlap with a first partial capacitance and a second overlap with a second partial capacitance are embodied between the metallization layers of the two film sides, and the partial capacitances form a series connection.

The arrangement of the metallization layers on the two film sides of the metallized dielectric film, by means of which the overlaps of the metallization layers and therefore the partial capacitors are embodied, has the advantage that partial discharges at the metallization layers and voltage breakdowns potentially resulting therefrom can be at least considerably reduced between different potentials of the metallization layers. In this context, metallization layers are preferably electrically isolated in relation to one another.

Due to the partial capacitors being formed directly on the metallized dielectric film of the film capacitor, it is also possible to dispense with carrier films that have often been used to date, which are not metallized dielectric films. This advantageously saves weight and reduces the overall volume of the film capacitor with capacitance values that are approximately comparable or remain the same.

Advantageous embodiments of the film capacitor are specified in the dependent claims.

In a first advantageous embodiment of the film capacitor, the first metallization layer is electrically contacted with the first contact layer and the second metallization layer is electrically contacted with the second contact layer and the third metallization layer is embodied as electrical contactless in relation to the first and second contact layer.

This electrical contactless metallization layer enables an improved structural technology, particularly also in relation to the electrical properties of the capacitor in relation to conventional film capacitors with only two metallization layers on a metallized dielectric film.

In a further advantageous embodiment of the film capacitor, the first and second metallization layer are applied on the first film side of the metallized dielectric film, the third metallization layer is applied on the second film side of the metallized dielectric film, the first overlap is embodied between the first and third metallization layer of the first and second film sides of the metallized dielectric film, and the second overlap is embodied between the second and third metallization layer of the first and second film sides of the metallized dielectric film.

If an arrangement of the first and second metallization layer on the first film side, and the contacting thereof with the first and second contact layer, is advantageously also to be retained in further metallization layers that are additionally to be applied on the two film sides, then metallization layers are to be applied on the first and the second film side of the metallized dielectric film by means of a mathematical series in a total number of 5 or 7 or 9 or 11—and so on—metallization layers, for example.

In this context, the application of the first, second and third metallization layers is to be followed in an alternating order after the third metallization layer.

In a further advantageous embodiment of the film capacitor, a fourth metallization layer is applied on the first or second film side of the metallized dielectric film, the fourth metallization layer is embodied as electrical contactless in relation to the first, second and third metallization layer, and by means of the fourth metallization layer a third overlap with a third partial capacitance is embodied between the metallization layers of the first and second film sides of the metallized dielectric film, and the series connection of first and second partial capacitance is expanded by the third partial capacitance.

The expanding of the capacitance on the one metallized dielectric film is advantageously possible with the embodiment of the third overlap and forming of the third partial capacitance.

In a further advantageous embodiment of the film capacitor, the first and the fourth metallization layer are applied on the first film side of the metallized dielectric film, the second and third metallization layer are applied on the second film side of the metallized dielectric film, the second overlap is embodied between the respective third and fourth metallization layer of the first and second film sides of the metallized dielectric film, and the third overlap is embodied between the respective second and fourth metallization layer of the first and second film sides of the metallized dielectric film.

If an arrangement of the first metallization layer on the first film side and the second metallization layer on the second film side, and the contacting thereof with the first and second contact layer, is advantageously also to be retained in further metallization layers that are additionally to be applied on the two film sides, then metallization layers are to be applied on the first and the second film side of the metallized dielectric film by means of a mathematical series in a total number of 6 or 8 or 10 or 12—and so on—metallization layers, for example.

In this context, the application of the first, second, third and metallization layers is to be followed in an alternating order after the fourth metallization layer.

In a further advantageous embodiment of the film capacitor, the first contact layer has a first electrical terminal and the second contact layer has a second electrical terminal.

By means of the terminals, the film capacitor can advantageously be electrically interconnected in a filter, for example.

In a further advantageous embodiment of the film capacitor, the film capacitor has at least a first and second metallized dielectric film, which are arranged in succession and in each case are embodied as metallized dielectric films.

in a further advantageous embodiment of the film capacitor, the respective metallization layers of the first and second metallized dielectric films are embodied in such a manner that the first metallization layer of the first metallized dielectric film lies opposite in relation to the first metallization layer of the second metallized dielectric film and/or the second metallization layer of the first metallized dielectric film lies opposite in relation to the second metallization layer of the second metallized dielectric film and/or the third metallization layer of the first metallized dielectric film lies opposite in relation to the third metallization layer of the second metallized dielectric film and/or, if present, the fourth metallization layer of the first metallized dielectric film lies opposite in relation to, if present, the fourth metallization layer of the second metallized dielectric film.

It proves to be advantageous if the first and second metallization layers, which lie opposite in each case, of the first and second metallized dielectric film, which are arranged in succession, are contacted with the same contact layer in each case.

Due to the opposite arrangement of two metallization layers, which lie at the same electrical potential due to being contacted with the same contact layer, voltage flashovers are substantially excluded at least between said metallization layers in a possible air gap.

This advantage is also comparable for the arrangement, lying opposite in each case, of the third and fourth metallization layers of the first and second metallized dielectric film, which in each case are embodied as contactless in relation to the first and second contact layer.

In a further advantageous embodiment of the film capacitor, the thicknesses of the first or second metallization layers of the first and second metallized dielectric films taper away from the contact layers contacted with them along the length over which they are applied.

In a further advantageous embodiment of the film capacitor, the thicknesses of the third or fourth metallization layers of the first and second metallized dielectric films taper in the direction toward the contact layers in each case along the length over which they are applied.

The following considerations form the basis for the advantageous effect of the tapering thicknesses of the respective metallization layers:

At a location at which, due to material unevennesses, the first metallized dielectric film with its metallization layers has a lower spacing from the successive second metallized dielectric films with their metallization layers, then, particularly if a different potential of the opposite metallization layers is present and a sufficiently high AC voltage is applied, a periodically repeating voltage flashover may take place, which at the location of the voltage flashover may remove an oxidation layer, which is fine to the extent desired, on one of the metallization layers.

The oxidation penetrates gradually deeper into said metallization layer, which also leads to a slight stripping of the same oxidation layer at this location. The spacing from the opposite metallization layer increases and this means that a voltage flashover at another location of the metallization layer becomes possible with less energy required. The metallization layers are thus stripped in a gradual, irregular, yet extensive manner, which increases the surface resistance of the film.

In the region where the first or second metallization layers of the first and second metallized dielectric film are contacted with the contact layers, where the flow of the charge carriers is at its highest, the increase in the surface resistance leads to a considerably greater increase in the parasitic overall resistance of the capacitor (ESR) than on the metallization layers lying opposite in each case, on which the charge carrier flow is low. This increase is, in a first approximation, inversely proportional to the stripping of the layer thickness of the metallization layers.

With current I remaining the same, the power loss P=RI² increases accordingly, which is converted into heat. If the thickness of the metallization layers now tapers, then the extensive stripping or oxidation of the free surface of the opposite metallization layers results in the capacitively active surface area of one of the opposite metallization layers beginning to be successively stripped. In locations, the metallization may also be completely oxidized, wherein this first takes place far from the contact layer owing to the tapering. Due to the stripping of the capacitively active surface area, the capacitance C of the film capacitor is reduced, and thus also the current I through the film capacitor according to I=C·dU/dt. Due to the tapering of the profile of the metallization layer, the power loss P=RI² can therefore be restricted during the oxidation-related degradation processes of the metallization layers, whereby an uncontrolled heating of the metallized dielectric films due to a critically increased power loss can be prevented.

In a further advantageous embodiment of the film capacitor, in each case at least one of the first metallization layers of the first and second metallized dielectric films arranged in succession has, on the first end face thereof, one or more first recesses for connecting to the first contact layer and/or in each case at least one of the second metallization layers of the first and second metallized dielectric films arranged in succession has, on the second end face thereof, one or more second recesses for connecting to the first contact layer.

In a further advantageous embodiment of the film capacitor, at least in each case one of the first and second metallized dielectric films arranged in succession has, on the first end face thereof, one or more third recesses for connecting to the first contact layer and/or at least in each case one of the first and second metallized dielectric films arranged in succession has, on the second end face thereof, one or more fourth recesses for connecting to the second contact layer.

The recesses have the advantage that an electrically improved low-resistance connection can be established between the first and second metallization layers and the respective contact layers, wherein the recesses on the first and second metallization layers embody a larger contacting surface area with the contact layers for the electrical connection than a solution without the recesses on the first and second metallization layers. The recesses also give a better hold for the mechanical connection of first and second metallization layer with the respective contact layer.

In a further advantageous embodiment of the film capacitor, a non-metallized dielectric film is arranged between the two metallized dielectric films, the non-metallized dielectric film has a third and fourth end face and the third end face of the non-metallized dielectric film is connected to the first contact layer and the fourth end face of the non-metallized dielectric film is connected to the second contact layer.

The two successive metallized dielectric films often have, on the metallization layers thereof lying opposite in each case, a roughness, which in the event of wedging could lead to the metallization loosening at the location of the wedging and, as a result, an air gap being formed which can cause partial discharges. The non-metallized dielectric film, which is arranged between the two metallized dielectric films, advantageously prevents this.

To achieve the object, a filter with the film capacitor according to the invention is likewise proposed.

The use of the film capacitor in the filter increases the overall availability of the filter, as partial discharges can be reduced by means of the film capacitor. It is also possible to reduce the weight and reduce the installation space for the film capacitor, which likewise has a positive influence on the overall weight and the overall size of the filter, in the sense of a reduction.

To achieve the object, a converter is furthermore proposed, which comprises the filter according to the invention for operating an electric machine on an electrical network.

The above-described characteristics, features and advantages of this invention, as well as the manner in which these are achieved, will become clearer and more readily understandable in connection with the following description of the exemplary embodiments, which are explained in more detail in conjunction with the figures, in which:

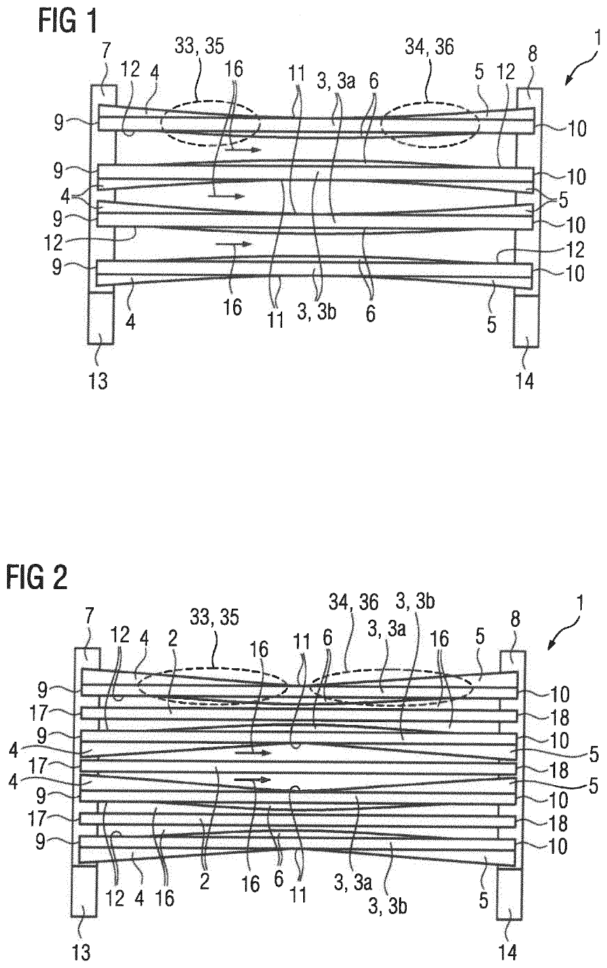

FIG. 1 shows a first schematic representation of a film capacitor according to the invention,

FIG. 2 shows a second schematic representation with a first exemplary embodiment of the film capacitor according to FIG. 1,

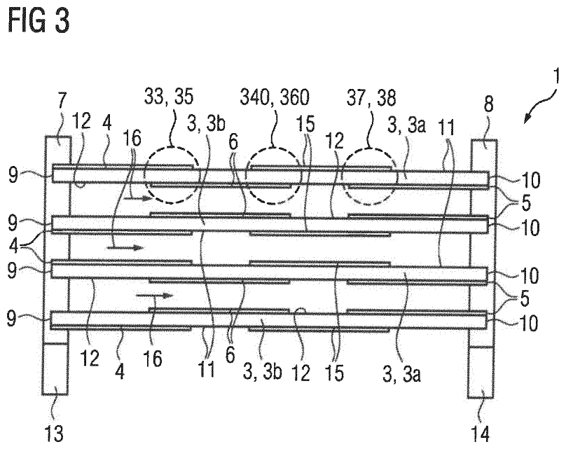

FIG. 3 shows a third schematic representation with a second exemplary embodiment of the film capacitor on the basis of FIG. 1,

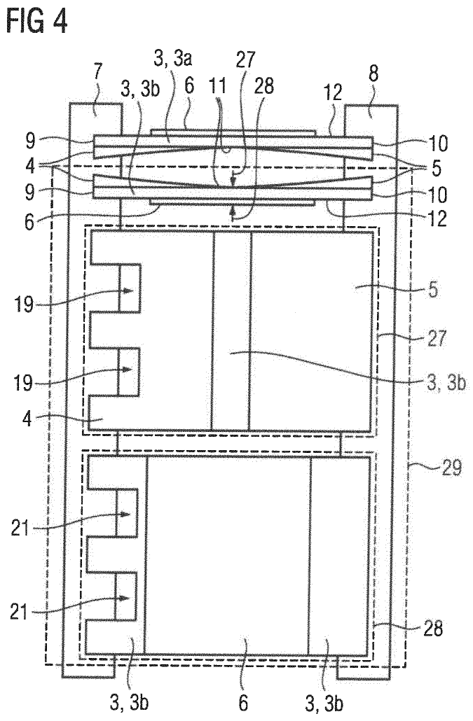

FIG. 4 shows a fourth schematic representation with a third exemplary embodiment of the film capacitor according to FIG. 1, wherein various viewing levels are set on a second metallized dielectric film of the film capacitor,

FIG. 5 shows a fifth schematic representation with a fourth exemplary embodiment of the film capacitor according to FIG. 1, wherein various viewing levels are set on a first metallized dielectric film of the film capacitor and

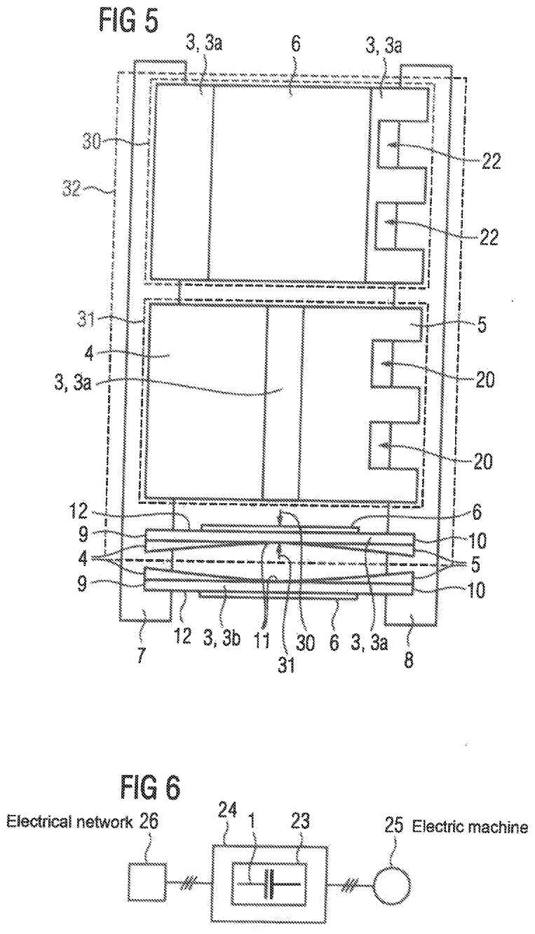

FIG. 6 shows a sixth schematic representation of a converter, which has a filter with the film capacitor according to the invention.

FIG. 1 shows a first schematic representation of a film capacitor 1 according to the invention.

Four metallized dielectric films 3 are shown, which are at least mechanically connected to a first contact layer 7 in each case by means of their first end faces 9 and to a second contact layer 8 in each case by means of their second end faces 10. To this end, the first contact layer 7 has a first electrical terminal 13 and the second contact layer 8 has a second electrical terminal 14.

The four metallized dielectric films 3 in each case have a first and second metallization layer 45 on a first film side 11 and a third metallization layer 6 on a second film side 12.

The first metallization layer 4 of the four metallized dielectric films 3 is in each case electrically connected to the first contact layer 7 and the second metallization layer 5 of the four metallized dielectric films 3 is in each case electrically connected to the second contact layer 8.

The third metallization layer 6 of the four metallized dielectric films 3 is in each case arranged in a contactless manner in relation to the first and second contact layer 7,8.

Three pairs are shown, with a first and second metallized dielectric film 3a,3b in each case, wherein the first and second metallized dielectric films 3a,3b of the three pairs are arranged in succession and in each case are embodied as metallized dielectric films 3.

Of the three pairs, in two pairs in each case two third metallization layers 6 lie opposite one another, and in the third pair in each case two first and second metallization layers 4,5 lie opposite one another.

In each case, an air gap 16 is embodied between the first and second metallized dielectric film 3a,3b of the three pairs.

The thicknesses of the first and second metallization layers 4,5 of the three pairs of the first and second metallized dielectric films 3a,3b taper away from the contact layers 7,8 contacted with them along the length over which they are applied.

The thickness of the third metallization layers 6 of the three pairs of the first and second metallized dielectric films 3a,3b taper in the direction of the contact layers 7,8 in each case along the length over which they are applied.

By way of example, on one of the first metallized dielectric films 3a, a first overlap 33 with a first partial capacitance 35 is embodied between the first metallization layer 4 and the third metallization layer 6 and a second overlap 34 is embodied between the second metallization layer 5 and the third metallization layer 6 with a second partial capacitance 36, wherein the two partial capacitances 35,36 form a series connection.

A second schematic representation with a first exemplary embodiment of the film capacitor 1 according to FIG. 1 is shown in FIG. 2.

FIG. 2 corresponds to FIG. 1, wherein a non-metallized dielectric film 2 is arranged between each of the metallized dielectric films 3.

The non-metallized dielectric films 2 are at least mechanically connected on their third end face 17 to the first contact layer 7 and with their fourth end face 18 to the second contact layer 8.

By means of FIG. 3, a second exemplary embodiment of the film capacitor 1 on the basis of FIG. 1 is shown in a third schematic representation.

Four metallized dielectric films 3 are also shown in FIG. 3, which are at least mechanically connected to a first contact layer 7 in each case by means of their first end faces 9 and to a second contact layer 8 in each case by means of their second end faces 10. To this end, the first contact layer 7 has a first electrical terminal 13 and the second contact layer 8 has a second electrical terminal 14.

The four metallized dielectric films 3 in each case have a first and fourth metallization layer 4,15 on a first film side 11 and a second and third metallization layer 5,6 on a second film side 12.

The first metallization layer 4 of the four metallized dielectric films 3 is in each case electrically connected to the first contact layer 7 and the second metallization layer 5 of the four metallized dielectric films 3 is in each case electrically connected to the second contact layer 8.

The third and fourth metallization layer 6,15 of the four metallized dielectric films 3 are in each case arranged in a contactless manner in relation to the first and second contact layer 7,8.

Three pairs are shown, with a first and second metallized dielectric film 3a,3b in each case, wherein the first and second metallized dielectric films 3a,3b of the three pairs are arranged in succession and in each case are embodied as metallized dielectric films 3.

Of the three pairs, in two pairs in each case two second and third metallization layers 5,6 lie opposite one another, and in the third pair in each case two first and fourth metallization layers 4,15 lie opposite one another.

In each case, an air gap 16 is embodied between the first and second metallized dielectric film 3a,3b of the three pairs.

A tapered representation of the metallization layers 4,5,6,15 of the four metallized dielectric films 3 is dispensed with in FIG. 3, which does not mean that they may not exist in this exemplary embodiment.

By way of example, on one of the first metallized dielectric films 3a, a first overlap 33 with a first partial capacitance 35 is embodied between the first metallization layer 4 and the third metallization layer 6, a second overlap 340 is embodied between the third metallization layer 6 and the fourth metallization layer 15 with a second partial capacitance 360 and a third overlap 37 is embodied between the fourth metallization layer 15 and the second metallization layer 5 with a third partial capacitance 38, wherein the three partial capacitances 35,360,38 form a series connection.

In a fourth schematic representation, FIG. 4 visualizes a third exemplary embodiment of the film capacitor 1 according to FIG. 1, wherein various viewing levels are set on a second metallized dielectric film 3b of the film capacitor 1.

Shown in a cross-sectional view are a first and a second metallized dielectric film 3a,3b, which are arranged in succession and in each case are embodied as metallized dielectric films 3.

The first and second metallized dielectric film 3a,3b are at least mechanically connected to a first contact layer 7 in each case by means of their first end faces 9 and to a second contact layer 8 in each case by means of their second end faces 10.

The two dielectric films 3a,3b in each case have a first and second metallization layer 45 on a first film side 11 and a third metallization layer 6 on a second film side 12.

The first metallization layer 4 of the two dielectric films 3a,3b is in each case electrically connected to the first contact layer 7 and the second metallization layer 5 of the two dielectric films 3a,3b is in each case electrically connected to the second contact layer 8.

The third metallization layer 6 of the two dielectric films 3a,3b is in each case arranged in a contactless manner in relation to the first and second contact layer 7,8.

The two first and second metallization layers 4,5 in each case of the two dielectric films 3a,3b lie opposite one another.

The thicknesses of the first and second metallization layers 4,5 of the first and second metallized dielectric films 3a,3b taper away from the contact layers 7,8 contacted with them along the length over which they are applied.

The thicknesses of the third metallization layers 6 of the first and second metallized dielectric films 3a,3b taper in the direction of the contact layers 7,8 in each case along the length over which they are applied.

Looking at the second metallized dielectric film 3b, a first overall view 29 has been chosen, which in addition to the cross-sectional view of the second metallized dielectric film 3b also shows a top view of the second metallized dielectric film 3b in a first view 27 and a bottom view of the second metallized dielectric film 3b in a second view 28. These two views 27,28 are also visualized on the cross-sectional view of the second metallized dielectric film 3b by means of an arrow for the first view 27 as top view and a further arrow for the second view 28 as bottom view.

The first view 27 as top view of the second metallized dielectric film 3b shows the first metallization layer 4, which is electrically and mechanically connected to the first contact layer 7 by means of two first recesses 19.

The second metallized dielectric film 3b, at the location of the two first recesses 19 of the first metallization layer 4, likewise has recesses, which however are hidden behind the two first recesses 19 of the first metallization layer 4.

The second metallization layer 5 is electrically and mechanically connected to the second contact layer 8 and in this exemplary embodiment has no recesses.

The second view 28 as bottom view of the second metallized dielectric film 3b shows the third metallization layer 6, which is arranged in an electrical contactless manner in relation to the first and second contact layer 7,8.

The second metallized dielectric film 3b is at least mechanically connected to the first contact layer 7 by means of two third recesses 21.

The recesses of the first metallization layer, at the location of the two third recesses 21 of the second metallized dielectric film 3b, likewise have recesses, which however are hidden behind the two third recesses 21 of the second metallized dielectric film 3b.

The second metallized dielectric film 3b is at least mechanically connected to the second contact layer 8 and in this exemplary embodiment has no recesses.

In a fifth schematic representation, FIG. 5 visualizes a fourth exemplary embodiment of the film capacitor 1 according to FIG. 1 and FIG. 4, wherein various viewing levels are set on a first metallized dielectric film 3a of the film capacitor 1.

FIG. 5 shows the same representation of the first and second metallized dielectric films 3a,3b as in FIG. 4, but in a different perspective.

Shown in the cross-sectional view are the first and second metallized dielectric film 3a,3b, which are arranged in succession and in each case are embodied as metallized dielectric films 3.

The first and second metallized dielectric film 3a,3b are at least mechanically connected to the first contact layer 7 in each case by means of their first end faces 9 and to the second contact layer 8 in each case by means of their second end faces 10.

The two dielectric films 3a,3b in each case have the first and second metallization layer 4,5 on the first film side 11 and the third metallization layer 6 on the second film side 12.

The first metallization layer 4 of the two dielectric films 3a,3b is in each case electrically connected to the first contact layer 7 and the second metallization layer 5 of the two dielectric films 3a,3b is in each case electrically connected to the second contact layer 8.

The third metallization layer 6 of the two dielectric films 3a,3b is in each case arranged in a contactless manner in relation to the first and second contact layer 7,8.

The two first and second metallization layers 4,5 in each case of the two dielectric films 3a,3b lie opposite one another.

The thicknesses of the first and second metallization layers 4,5 of the first and second metallized dielectric films 3a,3b taper away from the contact layers 7,8 contacted with them along the length over which they are applied.

The thicknesses of the third metallization layers 6 of the first and second metallized dielectric films 3a,3b taper in the direction of the contact layers 7,8 in each case along the length over which they are applied.

Looking at the first metallized dielectric film 3a, a second overall view 32 has been chosen, which in addition to the cross-sectional view of the first metallized dielectric film 3a also shows a top view of the first metallized dielectric film 3a in a third view 30 and a bottom view of the first metallized dielectric film 3a in a fourth view 31. These two views 30,31 are also visualized on the cross-sectional view of the first metallized dielectric film 3a by means of an arrow for the third view 30 as top view and a further arrow for the fourth view 31 as bottom view.

The third view 30 as bottom view of the first metallized dielectric film 3a shows the third metallization layer 6, which is arranged in an electrical contactless manner in relation to the first and second contact layer 7,8.

The first metallized dielectric film 3a is at least mechanically connected to the second contact layer 8 by means of two fourth recesses 22.

The recesses of the second metallization layer, at the location of the two fourth recesses 22 of the first metallized dielectric film 3a, likewise have recesses, which however are hidden behind the two fourth recesses 22 of the first metallized dielectric film 3a.

The first metallized dielectric film 3a is at least mechanically connected to the second contact layer 7 and in this exemplary embodiment has no recesses.

The fourth view 31 as bottom view of the first metallized dielectric film 3a shows the second metallization layer 5, which is electrically and mechanically connected to the second contact layer 8 by means of two second recesses 20.

The first metallized dielectric film 3a, at the location of the two second recesses 20 of the second metallization layer 5, likewise has recesses, which however are hidden behind the two second recesses 20 of the second metallization layer 5.

The first metallization layer 4 is electrically and mechanically connected to the second contact layer 8 and in this exemplary embodiment has no recesses.

In a sixth schematic representation, FIG. 6 shows a converter 24, which has a filter 23 with the film capacitor 1 according to the invention.

The filter 23 may be integrated in the converter 24 or, for example, also may be electrically interconnected between the electrical network 26 and the converter 24 or the electric machine 25 and the converter 24. In FIG. 6, it is interconnected in a three-phase system, by way of example.

The converter 24 is connected to an electrical network 26 and operates electric machine 25.

1.-15. (canceled)

6. A film capacitor, comprising:
first and second contact layers;
first and second metallized dielectric films arranged in succession, each said metallized dielectric film having first end face connected to the first contact layer, a second end face connected to the second contact layer, and first and second film sides; and
first, second and third metallization layers, with at least two of the first, second and third metallization layers being applied on the first film side of the metallized dielectric film and a further one of the first, second and third metallization layers being applied on the second film side of the metallized dielectric film, said first, second and third metallization layers being arranged on the first and second film sides of the metallized dielectric film in such a manner that a first overlap with a first partial capacitance and a second overlap with a second partial capacitance are embodied between the first, second and third metallization layers on the first and second film sides, with the first and second partial capacitances forming a series connection,
wherein the first metallization layer is electrically contacted with the first contact layer, the second metallization layer is electrically contacted with the second contact layer, and the third metallization layer is embodied as electrical contactless in relation to the first and second contact layers,
wherein the at least two of the first, second and third metallization layers of the first and second metallized dielectric films are embodied in such a manner that one of the at least two of the first, second and third metallization layers of the first metallized dielectric film lies opposite in relation to the one of the at least two of the first, second and third metallization layers of the second metallized dielectric film, and the other one of the at least two of the first, second and third metallization layers of the first metallized dielectric film lies opposite in relation to the other one of the at least two of the first, second and third metallization layers of the second metallized dielectric film, and
wherein the further one of the first, second and third metallization layers of the first and second metallized dielectric films have thicknesses which taper in a direction toward the first and second contact layers, respectively, along a length over which they are applied.

17. The film capacitor of claim 16, wherein the first and second metallization layers are applied on the first film side of the metallized dielectric film and the third metallization layer is applied on the second film side of the metallized dielectric film, with the first overlap being embodied between the first and third metallization layers of the first and second film sides of the metallized dielectric film, and with the second overlap being embodied between the second and third metallization layers of the first and second film sides of the metallized dielectric film.

18. The film capacitor of claim 16, further comprising a fourth metallization layer applied on one of the first or second film sides of the metallized dielectric film and embodied as electrical contactless in relation to the first, second and third metallization layers, wherein the fourth metallization layer is arranged such as to form a third overlap with a third partial capacitance between the first, second, third and fourth metallization layers on the first and second film sides of the metallized dielectric film, with the series connection of first and second partial capacitances being expanded by the third partial capacitance.

19. The film capacitor of claim 18, wherein the first and the fourth metallization layers are applied on the first film side of the metallized dielectric film, wherein the second and third metallization layers are applied on the second film side of the metallized dielectric film, with the second overlap embodied between the third and fourth metallization layers of the first and second film sides of the metallized dielectric film, and with the third overlap embodied between the second and fourth metallization layers of the first and second film skies of the metallized dielectric film.

20. The film capacitor of claim 16, wherein the first contact layer includes a first electrical terminal and the second contact layer includes a second electrical terminal.

21. The film capacitor of claim 16, wherein the third metallization layers of the first and second metallized dielectric films are embodied in such a manner that the third metallization layer of the first metallized dielectric film lies opposite in relation to the third metallization layer of the second metallized dielectric film.

22. The film capacitor of claim 18, wherein the fourth metallization layer of the first metallized dielectric film lies opposite in relation to the fourth metallization layer of the second metallized dielectric film.

23. The film capacitor of claim 16, wherein the first metallization layer of the first and second metallized dielectric films or the second metallization layer of the first and second metallized dielectric films tapers away from a respective one of the contacting first and second contact layers along a length over which it is applied.

24. The film capacitor of claim 18, wherein the fourth metallization layers of the first and second metallized dielectric films have thicknesses which taper respectively in a direction toward the first and second contact layers along a length over which they are applied.

25. The film capacitor of claim 16, wherein at least one of the first metallization layers of the first and second metallized dielectric films arranged in succession has, on the first end face thereof, at least one first recess for connecting to the first contact layer and/or at least one of the second metallization layers of the first and second metallized dielectric films arranged in succession has, on the second end face thereof, at least one second recess for connecting to the first contact layer.

26. The film capacitor of claim 25, wherein at least one of the first and second metallized dielectric films arranged in succession has, on the first end face thereof, at least one third recess for connecting to the first contact layer and/or at least one of the first and second metallized dielectric films arranged in succession has, on the second end face thereof, at least one fourth recess for connecting to the second contact layer.

27. The film capacitor of claim 16, further comprising a non-metallized dielectric film arranged between the two metallized dielectric films, said non-metallized dielectric film having third and fourth end faces, with the third end face of the non-metallized dielectric film connected to the first contact layer and the fourth end face of the non-metallized dielectric film connected to the second contact layer.

28. A filter, comprising a film capacitor, said film comprising first and second contact layers, first and second metallized dielectric films arranged in succession, each said metallized dielectric film having a first end face connected to the first contact layer, a second end face connected to the second contact layer, and first and second film sides, and first, second and third metallization layers, with at least two of the first, second and third metallization layers being applied on the first film side of the metallized dielectric film and a further one of the first, second and third metallization layers being applied on the second film side of the metallized dielectric film, said first, second and third metallization layers being arranged on the first and second film sides of the metallized dielectric film in such a manner that a first overlap with a first partial capacitance and a second overlap with a second partial capacitance are embodied between the first, second and third metallization layers on the first and second film sides, with the first and second partial capacitances forming a series connection, wherein the first metallization layer is electrically contacted with the first contact layer, the second metallization layer is electrically contacted with the second contact layer, and the third metallization layer is embodied as electrical contactless in relation to the first and second contact layers, wherein the at least two of the first, second and third metallization layers of the first and second metallized dielectric films are embodied in such a manner that one of the at least two of the first, second and third metallization layers of the first metallized dielectric film lies opposite in relation to the one of the at least two of the first, second and third metallization layers of the second metallized dielectric film, and the other one of the at least two of the first, second and third metallization layers of the first metallized dielectric film lies opposite in relation to the other one of the at least two of the first, second and third metallization layers of the second metallized dielectric film, and wherein the further one of the first, second and third metallization layers of the first and second metallized dielectric films have thicknesses which taper in a direction toward the first and second contact layers, respectively, along a length over which they are applied.

29. A converter, comprising a filter as set forth in claim 28 for operating an electric machine on an electrical network.
